(19) United States
(12) Patent Application Publication
(10) Pub. No.: US 2008/0183743 A1
(43) Pub. Date: Jul. 31, 2008

(54) Method and computer based system for performance management

(76) Inventor: Urjan Claassen, Eindhoven (NL)

Correspondence Address: THORNE & HALAJIAN;APPLIED TECHNOLOGY CENTER, 111 WEST MAIN STREET, BAY SHORE, NY, 11706, US

(21) Appl. No.: 11/736,640

(22) Filed: Apr. 18, 2007

Related U.S. Application Data
(60) Provisional application No. 60/887,337, filed on Jan. 30, 2007.

(51) Int. Cl. G06F 7/00

(52) U.S. Cl. 707/102; 707/E17.056

(57) ABSTRACT

A method for managing a performance of an organization, comprising a data input step (11) for gathering strategic data concerning the organization, an analysis step (12) for based on the gathered strategic data analyzing strengths and weaknesses of the organization, a strategic planning step (13) for based on the strengths and weaknesses defining at least one strategic objective for the organization, an organization planning step (14) for division of the at least one strategic objective into multiple partial objectives, and a personal planning step (15) for subdivision of the multiple partial objectives into personal objectives for the persons in the organization.

This application claims the benefit of U.S. Provisional Patent Application No. 60/887,337 filed Jan. 30, 2007.

### TECHNICAL FIELD OF THE PRESENT SYSTEM

The present system relates to a method and a computer based system for managing a performance of an organization.

### BACKGROUND OF THE PRESENT SYSTEM

In modern business, an increasing attention is observed for risk management and accountability. Society, banks, insurance companies, tax authorities, and others want insight in the goals and ambitions of organizations and in the risks that are taken and controlled while pursuing these objectives. In recent years, this growing attention has even influenced legislation on Corporate Governance. Examples of legislation on Corporate Governance are the Sarbanes Oxley Act in the United States and Code Tabaksblatt in the Netherlands. Businesses are obliged to implement a risk management system on operational and financial objectives. A commonly used tool used for observing the regulations on Corporate Governance is the Enterprise Risk Management Framework of the Committee of Sponsoring Organizations of the Treadway Commission (September 2004).

The Treadway Commission distinguishes differences between Enterprise Risk Management and Business Risk Management. The main difference concerns the focus on the creation of value within Enterprise Risk Management. Within the Enterprise Risk Management Framework the creation of value is also considered in terms of the realization of opportunities. In the Enterprise Risk Management Framework the management of opportunities and risks concern the same (kind of) activities. However, significant differences exist between opportunity and risk management. These differences are not considered within the Enterprise Risk Management Framework of the Treadway Commission. As a consequence, the Enterprise Risk Management Framework tools do not provide an accurate and complete picture of the performance of an organization.

### SUMMARY OF THE PRESENT SYSTEM

It is an object of the present system to provide a method for managing a performance of an organization, being better suited to plan and monitor risks as well as tasks and opportunities.

According to a first aspect of the present system, this object is achieved by providing a method for managing a performance of an organization comprising a data input step for gathering strategic data concerning the organization, an analysis step for based on the gathered strategic data analyzing strengths and weaknesses of the organization, a strategic planning step for based on the strengths and weaknesses defining at least one strategic objective for the organization, an organization planning step for division of the at least one strategic objective into multiple partial objectives and a personal planning step for division of the multiple partial objectives into personal objectives for the persons in the organization.

With the method according to the present system, the monitoring and analyzing of risks is integrated with monitoring and analyzing opportunities, thereby enabling formulating sensible strategic objectives for the organization. By first dividing the strategic objectives for the organization into partial objectives that can be accomplished by separate departments, project groups or business units and then subdividing the partial objectives into personal objectives for the persons in the organization, abstract company strategies may be automatically turned into concrete personal objectives.

In an embodiment, also a logging step and an effect determination step may be provided. The logging step is provided for monitoring a progress made by the persons in achieving the personal objectives. The effect determination step is provided for determining an effect of the monitored progress on the multiple partial objectives and, via the partial objectives, on the strategic objectives. In this embodiment the influence of the activities of each person on the partial goals and even on the strategic objectives of the organization may be made visible immediately.

It is also possible to adjust the strategic objectives and to determine the effect of this adjustment on multiple partial objectives. Possibly, also the effect of the adaptation of the multiple partial objectives on the personal objectives is determined. It is thereby made possible to visualize the effect of changing strategic objectives on individual persons in the organization.

In an embodiment, the analysis step comprises an analysis of the strengths, the weaknesses, the opportunities and the threats (SWOT) for internal as well as external factors.

Some or all planning steps may be performed based on the balanced scorecard (BSC), which seeks to measure a business from a financial perspective, a customer perspective, a business process perspective and a learning and growth perspective. If the logging step is also performed based on the balanced scorecard, the monitored progress can easily be compared to the various objectives.

According to a second aspect of the present system a computer based system is provided with a data input for receiving strategic data concerning the organization and a data storage for storing the received data. The system also comprises a processor arranged for based on the stored strategic data analyzing strengths and weaknesses of the organization, based on the strengths and weaknesses defining at least one strategic objective for the organization, dividing the at least one strategic objective into multiple partial objectives and dividing the multiple partial objectives into personal objectives for the persons in the organization. The system further comprises an output for providing the personal objectives to the persons in the organization. The system may comprise units for enabling performing the various advantageous method steps that are described above for the first aspect of the present system.

These and other aspects of the present system are apparent from and will be elucidated with reference to the embodiments described hereinafter.

### BRIEF DESCRIPTION OF THE DRAWINGS

In the drawings:

FIG. 1 shows a flow diagram of a basic embodiment of the method according to the present system,

FIG. 2 shows a flow diagram of a more advanced and detailed embodiment of the method according to the present system,

FIG. 3 shows a flow diagram of a method according to the present system comprising monitoring progress, and

FIG. 4 schematically shows an embodiment of the computer based system according to the present system.

### DETAILED DESCRIPTION OF THE PRESENT SYSTEM

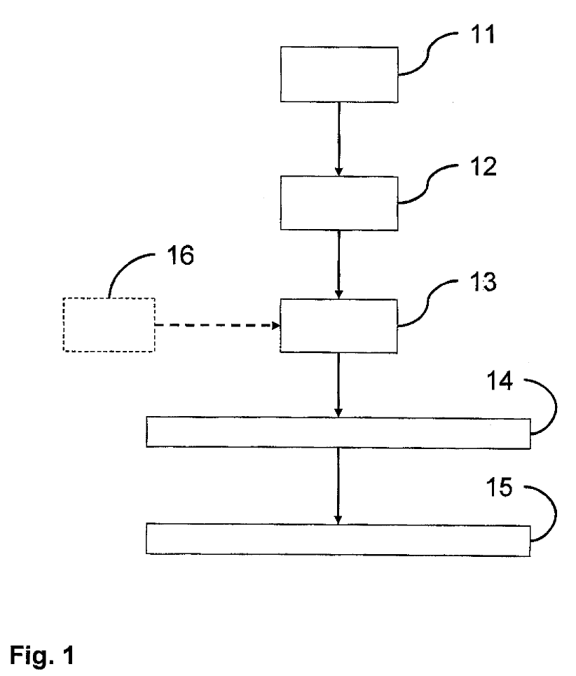

FIG. 1 shows a flow diagram of a basic embodiment of the method according to the present system. The method comprises a data input step 11 for obtaining all information about the organization that may be useful in later stages of the performance management method according to the present system. The received data may concern internal as well as external factors influencing the performance or the design of performance systems within the organization. Data concerning the internal factors may concern the employees, production resources, production processes, financial position, hierarchical structure, accommodation and much more. The data concerning the external factors may concern information about customers, suppliers, competitors, law, infrastructure, supply and demand and much more.

In analysis step 12 all received information is combined to generate an overview of all strengths and weaknesses of the organization. This overview is based on an internal and an external analysis. Based on the overview of strengths and weaknesses, strategic objectives may be formulated in strategic planning step 13. The strategic objectives may be formulated by a manager, managing director or one or more other decision taking employees. Alternatively, the strategic objectives may be generated automatically by a computer program. The strategic objectives may be formulated using a combination of human input 16 and a computer program. For example, the computer program may, based on the overview of strengths and weaknesses present some multiple-choice questions to the responsible employee and the answers to those questions may then form a basis for the strategic objectives.

Strategic objectives reflect the goals and ambitions of the organization as a whole. However, in large organizations the strategic objectives may be generally too vague for individual employees to adapt their behavior in such a way that the strategic objectives may be easily realized. Therefore, in an organization planning step 14, the strategic objectives may be divided into multiple smaller and more concrete partial objectives. Part of the input data concerning the hierarchical and organizational structure of the organization may be used to delegate concrete partial objectives to those departments or groups in the organization that may be equipped to realize those partial objectives.

In personal planning step 15, the multiple partial objectives may be subdivided into personal objectives for individual persons in the organizations. The received input data may be used again for assigning tasks to persons who are capable to and responsible for performing such tasks. In the personal planning step, the personal tasks, wishes and capabilities of the employee, as received in the data input step 11, may be taken into account. In addition the personal plan may embody the functional areas of responsibilities and competencies.

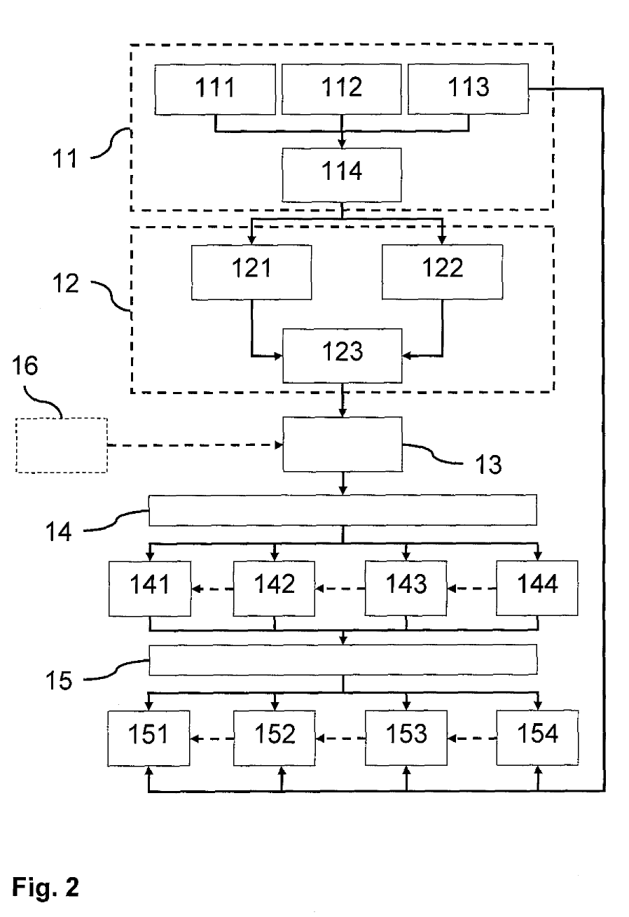

FIG. 2 shows a flow diagram of a more advanced and detailed embodiment of the method according to the present system. The data input step 11, uses a strategic window 114 for defining the strategic environment for the strategy formulation process. This environment comprises three management areas, being the company model 111, the financial data 112 and the control concept 113. A good understanding of the strategic environment is essential for an effective strategy formulation process.

The company model 111 provides a schematic view of the economic network of which the organization is an element. For example, the company model described by Robert Knechel may be used. The company model 111 is used for analyzing the strategic position of the organization and shows dependencies between processes, internal and external factors. Details describing competitors, suppliers, infrastructure, the macro economic situation, available technology, customers, potential customers and many other factors may be comprised in the company model. The relevance of different dependencies in the company model 111 may vary. In general, three factors influence the relevance of the dependencies. First, dependencies are directly related to the most important capabilities of the organization. Second, dependencies represent unaccomplished opportunities. Third, dependencies represent critical weaknesses.

Financial data 112 is necessary for controlling an organization. Control based on financial data usually occurs by comparing different types of financial data. Ex-ante and ex-post data may be distinguished. Ex-ante data relates to, e.g., budgets and forecasts. Ex-post data relates to, e.g., annual reports and expenditure summaries. The debits and credits may be sorted in categories relating to categories used for the analysis step 12.

Some organizations may use sometimes unexpressed and possibly emotional premises with respect to the manner of control and cooperation. The implementation of processes is essentially determined by human behavior. Behavioral rules may be implemented for making effective cooperation of these people possible. These behavioral rules are meant to cause the employees to show desired behavior. The behavioral rules are worked out in the control concept 113. The control concept 113 may comprise, e.g., the following elements: mission and key values, functional profiles, functional result areas, responsibilities for monitoring developments in the company model, performance indicators, accountability structure, planning and reporting structure and data and competencies. In the control concept, key values for, e.g., the business and specific functions may be rated in accordance with their relevance to the performance of the organization. Key values may be linked to functions and functions may be linked to responsibilities. Especially responsibilities with respect to evaluating performances are important to be clearly defined, Some performance indicators may be more important than others, which may be indicated by categorizing the performance indicators.

The analysis step 12 is split up into an external analysis 121 for analyzing the developments in the environment of the organization and an internal analysis 122 for analyzing financial aspects of the organization and other relevant developments within the organization, derived from the control concept 113 and the company model 111. Part of the internal analysis 122 may, e.g., be realized by a manager giving scores to different skills of the employees or to the applicability of variety of statements concerning the performance of the organization. The company model 111 is an important source for the external analysis 123. By combining the result of these two analyses in a combining step 123, the risks and opportunities for the organization may be demonstrated. An important aspect of the combining step 123 is relating internal strengths and weaknesses to external threats and opportunities. All performed analyses may be complete SWOT-analyses, considering all Strengths, Weaknesses, Opportunities and Threats.

Based on the most important strengths and weaknesses, threats and opportunities derived from the analysis 12, strategic objectives may be formulated in strategic planning step 13. Different scenarios may be generated from the analysis data. A scenario may comprise the following elements: product focus, related marketing mix, relevant elements from the SWOT analyses, descriptions of targets and related performance indicators and actions, gross margin analysis, profit and loss and discontinued cash flow calculation. From these generated scenarios, one or more may be selected as a strategic object. The strategic objectives may be selected or formulated by a manager, managing director or one or more other decision taking employees. The strategic plan may comprises, objectives, targets to be reached for achieving the objectives and actions or projects to be started for reaching the targets.

In the method according to FIG. 2, the organization planning step 14 and the personal planning step 15 may be performed in accordance with the concept of the balanced scorecard (BSC). Also, the strategic plan may be made in accordance with the balanced scorecard. The balanced scorecard was introduced in 1992 by Robert S. Kaplan and David Norton as a concept for measuring a company's activities in terms of its vision and strategies. The balanced scorecard gives a comprehensive view of the performance of a business. The balanced scorecard measures a business from the following perspectives: financial perspective 141, 151, customer perspective 142, 152, business process perspective 143, 153, and teaming and growth perspective 144, 154. Optionally, also the strategic planning step 13 uses the balanced scorecard. The performances with respect to the four perspectives may be interrelated. Good performance from a learning and growth perspective 144, 154, leads to improved business processes 143, 153, which leads to more and more satisfied customers. Improvement with respect to the customer perspective 142, 152, leads to a better financial position 141, 151.

In the organization planning step 14, strategic objectives for, e.g., the first five years of the scenario may be worked out in more detail. Strategic objectives may be divided into multiple partial objectives per department.

As shown in FIG. 2, the control concept 113 may be used for working out the different aspects of the personal planning step 15. Functional responsibilities and competencies may be included in the personal plan. For example, functional profiles or assigned responsibilities may influence the planning of tasks for a person in the organization. Although not shown in FIG. 2, the control concept 113 may also influence the division of the strategic objective into multiple partial objectives in the organization planning step 14.

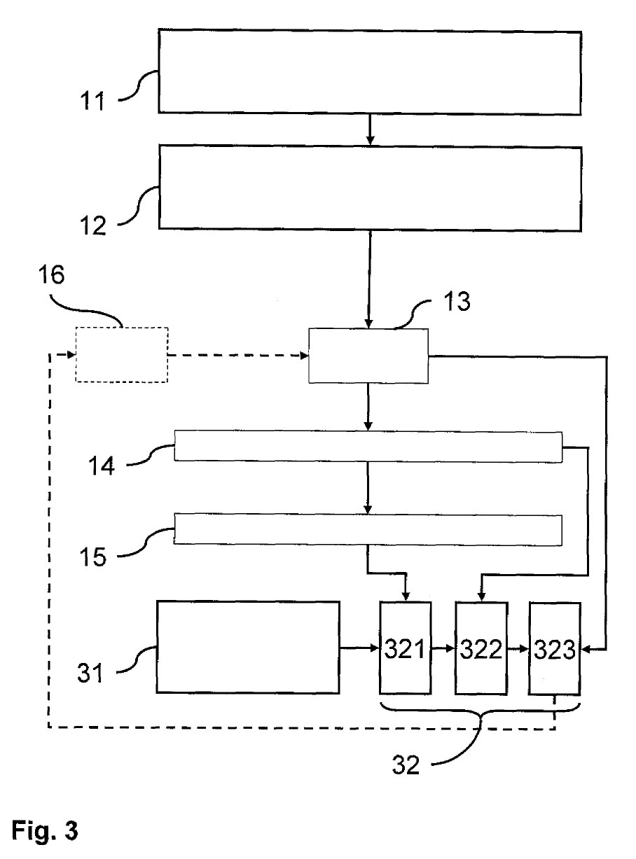

FIG. 3 shows a flow diagram of a method according to the present system comprising monitoring progress. Compared with the methods of FIG. 1 and FIG. 2, the method of FIG. 3 comprises two additional steps; a logging step 31 and an effect determination step 32. After the strategic objective, the multiple partial objectives and the personal objectives have been determined all persons in the organization may report their progress with respect to meeting the personal objectives. The reporting of the progress may be performed by filling in a progress registration form, e.g., once a day, once a week or once a month, on an individual and/or on a company level. Employees may report actual performance on identified personal objectives, job appraisals, progress on tasks performed, developments in the company model and how much time they spent on performing said tasks. Progress on the company level may be derived from available information from financial administration software and overviews of supplies or sold products. Such information may be used as input for the evaluations of the formulated plans. The reporting may also be automated, for example, by automatically counting a number of products produced or amount of materials used. The applied method for reporting mainly depends on the kind of action that is to be logged. If the personal objectives are formulated with reference to the balanced scorecard, the logged activities may also be grouped according to the four perspectives of the balanced scorecard.

In an effect determination step 32, the information collected in the logging step 31 is analyzed and the effect of the logged activities on the achieving of the objectives is determined. In the preceding planning process, actions and performances of individual persons have been linked to specific projects, targets, BSC dimensions, objectives and SWOT elements. These predetermined relations may be used for determining the effect of the logged activities on the achieving of the formulated objectives. In the method according to FIG. 3, the effect determination step 32 is subdivided in three consecutive steps 321, 322 and 323. In the first effect determination step 321, the effect of the logged activities on the personal objectives is determined. The monitoring of the progress enables the person himself as well as others in the organization, e.g. project leaders or managers, to evaluate the success of the plans while the plans are still being executed and to change the person's activities if needed. Optionally, differences between targets and logged results may be visualized by a computer program. For example, traffic lights may be used for indicating how much the results deviate from the targets. An e-mail may be sent to responsible persons when the results deviate more than a threshold percentage from the target.

The effect of the logged activities on the personal objectives does also have an effect on one or more of the partial objectives. In the second effect determination step 322, the indirect effect of the logged activities on the partial objectives is determined. In a third effect determination step 323, the determined effect on the partial objectives may be further used for determining whether the strategic objectives are still achievable. After all three consecutive effect determination steps 321, 322 and 323 are performed, the effect of the logged activities on the realization of the strategic objective is known. If all persons in the organization log their activities, the combined contributions of all persons to the realization of the strategic objective may be watched during the execution of the plans. As a result of the evaluation process, a manager or project leader may decide to change the strategic objectives. Adjustments to the strategic objectives may influence the partial objectives and personal objectives. Tasks of individual persons in the organization may change accordingly. During the execution of the plans, also the company model 111, the financial data 112 or the control concept 1113 may change. These changes may be logged and the effect of these changes on the analysis 12, the strategic plan 13, the business plan 14 and the personal plan 15 is determined. When, due to changes in the strategic environment significant changes in the strengths, weaknesses, opportunities or threats occur, one or more persons in the organization may be automatically notified, e.g. by e-mail. An e-mail may also be sent in the event of poor performance on the individual or company level. In response to the changes, the objectives may be changed automatically or by interference of the manager or project leader.

In addition to changing objectives in response to logged activities and performances, objectives, targets, projects and tasks may also be changed in response to changing internal and external factors. When people leave the company, their tasks may be assigned to other people in the organization, which will obviously affect other tasks and targets of those people. Furthermore, prices of required materials may change, customer behavior may change because of changing economic situation or competitors may perform surprisingly well or bad. Not all changes have to initiate adaptation of the short term objectives, targets and task assignments. Changes may, e.g., only affect predicted results and long term objectives. When processes tend to diverge from the predictions and objectives, a manager may be asked whether to accept it as a fact or to adjust some parameters of the earlier determined strategy.

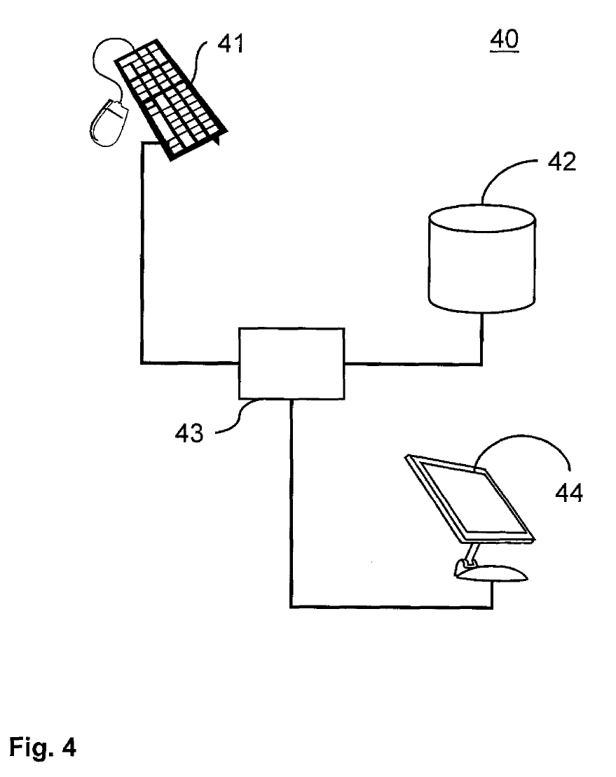

FIG. 4 schematically shows an embodiment of the computer based system 40 according to the present system. The computer based system 40 comprises input means 41, such as a keyboard and mouse or other type of pointing device. The system 40 further comprises a processor 43, storage means 42 and output means 44. The system may run on a central server and many or even all persons in the organization provide input to the system using their own PC, PDA, notebook or mobile phone as input means 41. The processor 43 processes all input data and stores the input data and processed data on the storage means 42. All the method steps described above may be performed by the processor 43. Part of these method steps may be performed fully automatic, other steps may require user input. The results of the analyses, the objectives, surveys of the strategic environment and much more information may be provided to the users on a display screen, or printed on paper. Notifications of changes and daily, weekly or monthly reports may be sent to one or more users by e-mail or SMS.

For most persons in the organization, access to the system may be limited to reporting their own activities. Group managers, project leaders and others may be authorized to provide inputs to more or even all parts of the system. Persons responsible for the financial administration may provide the financial data. Some persons in the organization may only be authorized to view part of the objectives, analysis results, financial data or other information. Some information may be public and, e.g., published on a website on the Internet.

It should be noted that the above-mentioned embodiments illustrate rather than limit the present system, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The present system may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A method for managing a performance of an organization, comprising the following sequence of steps:
a data input step (11) for gathering strategic data concerning the organization,
an analysis step (12) for based on the gathered strategic data analyzing strengths and weaknesses of the organization,
a strategic planning step (13) for based on the strengths and weaknesses defining at least one strategic objective for the organization,
an organization planning step (14) for division of the at least one strategic objective into multiple partial objectives, and
a personal planning step (15) for subdivision of the multiple partial objectives into personal objectives for the persons in the organization.

2. The method of claim 1, wherein the strategic data comprises:
a model (111) of the organization,
financial data (112), and
a control concept (113) with behavioral rules for persons in the organization.

3. The method of claim 1, further comprising:
a logging step for monitoring a progress made by the persons in achieving the personal objectives, and
an effect determination step, for determining an effect of the monitored progress on the multiple partial objectives and, via the partial objectives, on the strategic objectives.

4. The method of claim 1, further comprising:
a step of adjusting the strategic objective, and
a step of determining the effect of the adjustment on the multiple partial objectives and, via the partial objectives, on the personal objectives.

5. The method of claim 1, wherein the analysis step comprises a SWOT analysis of internal and external factors of the organization.

6. The method of claim 1, wherein the analysis step comprises a presenting a set of statements to a user and assessing the applicability of the statements to the organization by a user.

7. The method of claim 1, wherein the strategic planning step, the organization planning step and/or the personal planning step are performed based on a balanced scorecard.

8. The method of claim 1, wherein the strategic planning step comprises generating multiple scenarios based on the strengths and weaknesses, presenting the scenarios to a user and selection of one of the scenarios by the user.

9. The method of claim 3, wherein the personal planning step and the logging step are performed based on a balanced scorecard.

10. A computer based system for managing a performance of an organization, comprising:
a data input for receiving strategic data concerning the organization,
a data storage for storing the received data
a processor arranged for
based on the stored strategic data analyzing strengths and weaknesses of the organization,
based on the strengths and weaknesses defining at least one strategic objective for the organization,
dividing the at least one strategic objective into multiple partial objectives, and
subdividing the multiple partial objectives into personal objectives for the persons in the organization, and
an output for providing the personal objectives to the persons in the organization.

11. A computer program product for managing a performance of an organization, which program is operative to cause a processor to perform the method as claimed in any of the claims 1 to 9.
